(19) United States
(12) Patent Application Publication
(10) Pub. No.: US 2020/0402026 A1
(43) Pub. Date: Dec. 24, 2020

(54) BLOCKCHAIN MANAGEMENT SYSTEM, BLOCKCHAIN MANAGEMENT APPARATUS, INFORMATION PROVIDING APPARATUS, AND BLOCKCHAIN MANAGEMENT METHOD

(71) Applicant: NEC CORPORATION, Tokyo (JP)

(72) Inventor: Ryo FURUKAWA, Tokyo (JP)

(73) Assignee: NEC CORPORATION, Tokyo (JP)

(21) Appl. No.: 16/965,042

(22) PCT Filed: Feb. 27, 2018
(86) PCT No.: PCT/JP2018/007207

§ 371 Date: Jul. 27, 2020

(51) Int. Cl. G06Q 20/06; G06Q 20/36; G06Q 20/40; H04L 9/06

(52) U.S. Cl. CPC G06Q 20/0655; G06Q 20/3674; G06Q 20/401; G06Q 2220/00; H04L 2209/38; H04L 2209/56; H04L 9/0637

(57) ABSTRACT

When generating a block, a first blockchain management apparatus receives, from a prescribed information providing apparatus, a digest value generated from ledger information and a prescribed payment address, and the prescribed payment address, and generates a block. A second blockchain management apparatus verifies the block on the condition that the block that was received from the first blockchain management apparatus includes at least the digest value generated from the ledger information and the prescribed payment address, and a second transaction whereby consideration for providing the ledger information is paid to the prescribed payment address. In a case where verification of the block is successful, the second blockchain management apparatus forms a consensus with another blockchain management apparatus and adds the block for which consensus was formed to the ledger.

### CROSS REFERENCE TO RELATED APPLICATIONS

This application is a National Stage of International Application No. PCT/JP2018/007207 filed Feb. 27, 2018.

### FIELD

The present invention relates to a blockchain management system, a blockchain management apparatus, an information providing apparatus, a blockchain management method and a program.

### BACKGROUND

In recent years, as represented by Bitcoin (refer to Non-Patent Literature 1), in Peer to Peer (P2P) networks in which anyone can participate without the need for a centrally managed server, there has been increasing growth in blockchain where ledgers shared among all nodes participating in a network can be managed.

Blockchain as represented by Bitcoin is a system in which a plurality of blockchain management nodes (blockchain management apparatuses) are connected to one another. A blockchain management node is provided with a ledger storage means, a transaction verification means and a consensus formation means. The ledger storage means stores transactions published by a transaction publisher that publishes history information (referred to below as “transaction”) to be stored in a blockchain. The transaction verification means verifies transactions. The consensus formation means performs processing (called “consensus formation”; also known as “mining”) to make identical the content of transactions stored among the blockchain management nodes. The transactions stored in the ledger storage means, with a block being a unit in which one or a plurality of transactions are aggregated as a data structure, are characterized by including a block header that includes a hash value of, among the blocks, at least the previous block. An aggregation of blocks stored in this way is called a ledger.

An outline of how the blockchain operates is given below. Each blockchain management node receives 1 or a plurality of transaction information items published by 1 or a plurality of transaction publishers. The transaction verification means performs verification of the received 1 or plurality of transaction information items, and aggregates at least 1 transaction that has passed the verification to form a block. Block content may differ in each blockchain management node. Therefore, the consensus formation means makes identical the content of blocks stored among the blockchain management nodes. The blocks made identical in the respective blockchain management nodes by the consensus formation means are stored in the ledger storage means.

An incentive is designed so that the blockchain management nodes receive transactions and correctly generate and store blocks. For example, with Bitcoin, by generating blocks a blockchain management node can obtain a virtual currency. As a result, many blockchain management nodes have a behavior to correctly verify and generate blocks.

By this type of configuration and behavior, even in a case where a malicious node participates as a blockchain management node, falsification is difficult, and contents of ledgers at respective blockchain management nodes are identical and transactions are stored in the same order.

Since in blockchain there are multiple blockchain management nodes with the abovementioned configuration and behavior, and all data is managed by being duplicated, it is expected that in addition to data not being falsified, data will not be lost. Using this quality of blockchain, service emerges where data is recorded in the form of a transaction and the blockchain is used as a database system.

Patent Literature 1 discloses a virtual currency management program and a virtual currency management method in which it is possible to reduce the processing capability and storage capacity of a terminal that are required in the above consensus formation (mining).
[PTL 1] Japanese Patent Kokai Publication No. JP2016-218633A
[NPTL 1] Satoshi Nakamoto, “Bitcoin: A Peer-to-Peer Electronic Cash System”, 2008.

### SUMMARY

The following analysis is given according to the present invention. An incentive is designed so that the virtual currency system as represented by the abovementioned Bitcoin correctly generates and stores blocks. Thus there is a problem in that information for all the blockchain management nodes to correctly generate blocks are held and stored, and storage costs for the overall network increase.

As a countermeasure, a mode is implemented in which transactions that are actually unnecessary in Bitcoin are discarded and ledger capacity can be reduced. However, if motivation for holding ledger data diminishes in the overall network, the possibility of loss of important data contained in the ledger increases.

It is an object of the present invention to provide a blockchain management system, a blockchain management apparatus, an information providing apparatus, a blockchain management method and a program that can contribute to reducing storage costs in an overall network, while curbing the possibility of loss of ledger data in a blockchain.

According to a first aspect the invention provides a blockchain management system that includes an information providing apparatus, a first blockchain management apparatus, and a second blockchain management apparatus. The information providing apparatus provides a prescribed payment address and a digest value generated from the ledger information and the payment address to a blockchain management apparatus. The first blockchain management apparatus generates a block including a first transaction, using information provided by the information providing apparatus. The second blockchain management apparatus is provided with a block verification part that verifies a block on a condition that the block received from the first blockchain management apparatus includes at least the digest value generated from the ledger information and the payment address, and a second transaction whereby consideration for providing the ledger information is paid to the prescribed payment address, and a consensus formation part that, in a case where verification of the block is successful, forms a consensus with another blockchain management apparatus and adds the block for which consensus was formed to the ledger.

According to a second aspect the invention provides a first blockchain management apparatus that receives a prescribed payment address and a digest value generated from the ledger information and the payment address, from a prescribed information providing apparatus, and uses information provided by the information providing apparatus to generate a block that includes a first transaction, the digest value generated from the ledger information and a payment address, and a second transaction whereby consideration for providing the ledger information is paid to the prescribed payment address.

According to a third aspect the invention provides a second blockchain management apparatus including: a block verification part that verifies a block on a condition that the block received from a first blockchain management apparatus includes at least a digest value generated from ledger information and a prescribed payment address, and a second transaction whereby consideration for providing the ledger information is paid to the prescribed payment address; and a consensus formation part that, in a case of success in verification of the block, forms consensus with another blockchain management apparatus, and adds the block for which consensus has been formed to the ledger.

According to a fourth aspect the invention provides an information providing apparatus including: a ledger storage part that manages a ledger configuring a blockchain; an address information storage part that holds a payment address that is for paying a consideration for providing data held in the ledger storage part; and an information providing part that provides the prescribed payment address and a digest value generated from the ledger information and the payment address, to a blockchain management apparatus.

According to a fifth aspect the invention provides a blockchain management method wherein a blockchain management apparatus: verifies a block on a condition that a block received from another blockchain management apparatus includes at least a digest value generated from ledger information and a prescribed payment address, and a second transaction whereby consideration for providing the ledger information is paid to the prescribed payment address; and performs, in a case of success in verification of the block, consensus formation with another blockchain management apparatus, and adds the block for which the consensus formation has been done to the ledger. The present method is associated with a particular mechanism, which is a blockchain management apparatus that updates a ledger in collaboration with another blockchain management apparatus.

According to a sixth aspect the invention provides a program that causes a computer configuring a blockchain management apparatus to execute processing comprising: verifying a block on a condition that a block received from another blockchain management apparatus includes at least a digest value generated from ledger information and a prescribed payment address, and a second transaction whereby consideration for providing the ledger information is paid to the prescribed payment address; and performing, in a case of success in verification of the block, consensus formation with another blockchain management apparatus, and adding the block for which the consensus formation has been done to the ledger. It is to be noted that this program may be recorded on a computer-readable (non-transient) storage medium. That is, the present invention may be embodied as a computer program product.

According to the present invention it is possible to reduce storage costs of an entire network while curbing the possibility of loss of ledger data in a blockchain.

### BRIEF DESCRIPTION OF THE DRAWINGS

FIG. 1 is a diagram showing an example embodiment of the present invention.

FIG. 2 is a diagram illustrating operations of an example embodiment of the invention.

FIG. 3 is a diagram illustrating operations of an example embodiment of the invention.

FIG. 4 is a diagram illustrating operations of an example embodiment of the invention.

FIG. 5 is a diagram showing a configuration of a blockchain management system in the first example embodiment of the invention.

FIG. 6 is a functional block diagram showing a configuration of an information providing apparatus in the first example embodiment of the invention.

FIG. 7 is a functional block diagram showing a configuration of a blockchain management apparatus in the first example embodiment of the invention.

FIG. 8 is a diagram showing an example of a block created by a blockchain management apparatus in the first example embodiment of the invention.

FIG. 9 is a flowchart representing operations of the blockchain management apparatus in the first example embodiment of the invention.

FIG. 10 is a diagram showing an example of ledger data held in a ledger storage part of the blockchain management apparatus in the first example embodiment of the invention.

FIG. 11 is a flowchart representing operations (provision of information for block generation) of the information providing apparatus in the first example embodiment of the invention.

FIG. 12 is a flowchart representing operations (block verification) of the blockchain management apparatus in the first example embodiment of the invention.

FIG. 13 is a flowchart representing operations (consensus formation) of the blockchain management apparatus in the first example embodiment of the invention.

FIG. 14 is a functional block diagram showing a configuration of a blockchain management apparatus in a second example embodiment of the invention.

FIG. 15 is a diagram showing typical operations in the second example embodiment of the present invention.

FIG. 16 is a functional block diagram showing a configuration of an information providing apparatus in a third example embodiment of the invention.

FIG. 17 is a functional block diagram showing a configuration of a blockchain management apparatus in the third example embodiment of the invention.

FIG. 18 is a flowchart representing operations (provision of information for block verification) of the information providing apparatus in the third example embodiment of the invention.

### PREFERRED MODES

First, a description is given of an outline of an example embodiment of the present invention, making reference to the drawings. It is to be noted that reference symbols in the drawings attached to this outline are added to respective elements for convenience as examples in order to aid understanding, and are not intended to limit the present invention to modes illustrated in the drawings. Connection lines between blocks in the diagrams referred to in the following description include both unidirectional or bidirectional. Unidirectional arrows schematically show flow of main signals (data), but do not exclude bidirectionality.

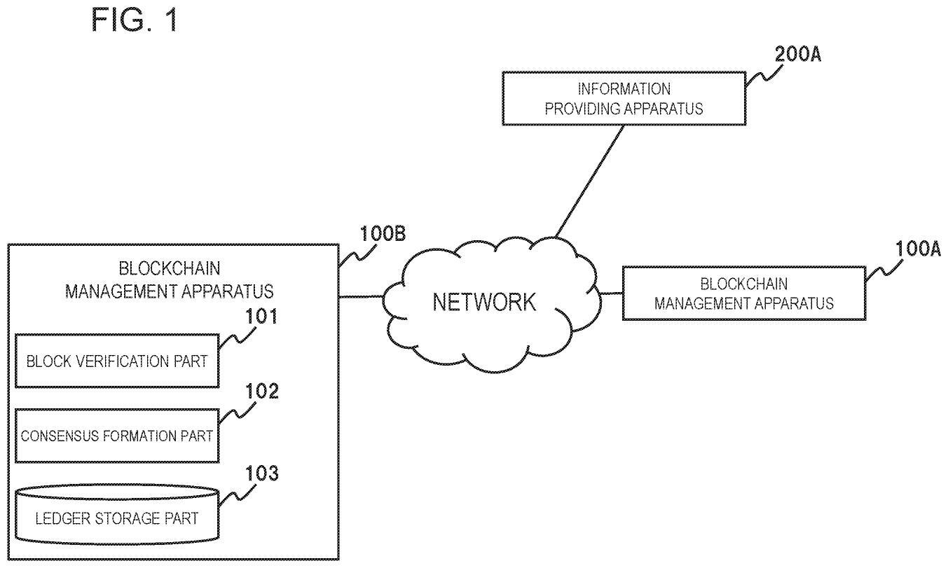

The present invention, in an example embodiment thereof as shown in FIG. 1, provides a blockchain management system including an information providing apparatus 200A, a first blockchain management apparatus 100A, and a second blockchain management apparatus 100B. The information providing apparatus 200A provides a prescribed payment address and a digest value generated from ledger information and the payment address, to the first blockchain management apparatus 100A. The blockchain management apparatus 100A generates a block including a first transaction, using information provided by the information providing apparatus 200A.

The blockchain management apparatus 100B is provided with a block verification part 101, a consensus formation part 102, and a ledger storage part 103. The block verification part 101 performs verification to confirm whether or not a block received from the blockchain management apparatus 100A is legitimate with regard to at least the following viewpoints.

(1) A digest value generated from the ledger information and payment address is included.
(2) A second transaction is included whereby consideration for providing the ledger information is paid to the prescribed payment address.
In a case where the above conditions (1) and (2) are confirmed, the block verification part 101 determines that the received block is correctly generated.

The consensus formation part 102, in a case of success in the block verification, forms a consensus with other blockchain management apparatuses (omitted from the drawings), and the block for which consensus has been formed is added to a ledger stored in the ledger storage part 103. It is to be noted that in the description below, the blockchain management apparatus 100A generates a block, and the blockchain management apparatus 100B performs verification, but this may change according to which generates the block earlier. That is, in a case where the blockchain management apparatus 100B generates the block earlier, the blockchain management apparatus 100A may verify the block generated by the blockchain management apparatus 100B. Clearly, in a case where another blockchain management apparatus (omitted from the drawings) generates the block earlier, the blockchain management apparatus 100A or 100B may be a verification node.

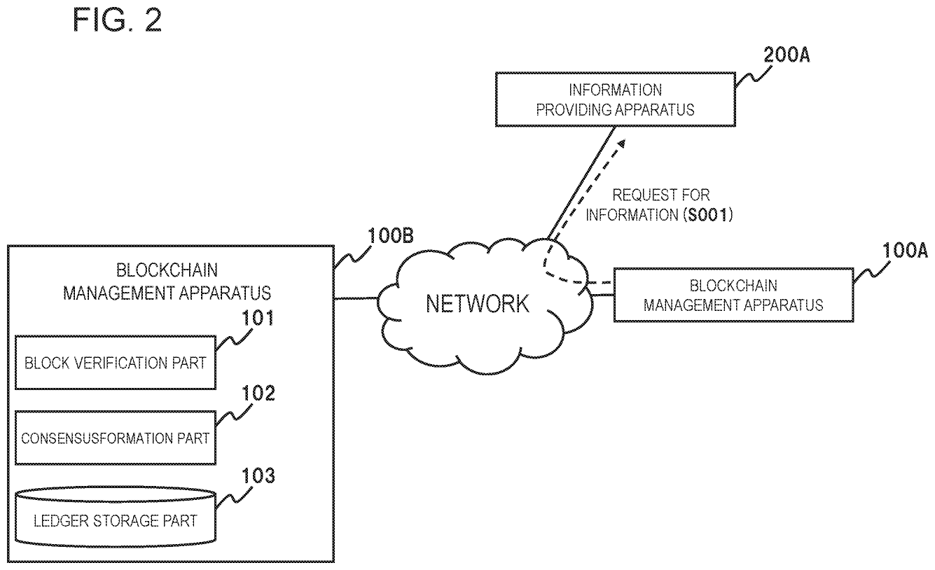

As shown in FIG. 2 for example, the blockchain management apparatus 100A that does not hold complete ledger data (corresponding to a first blockchain management apparatus), at block creation, makes a request for information to the information providing apparatus 200A (step S001).

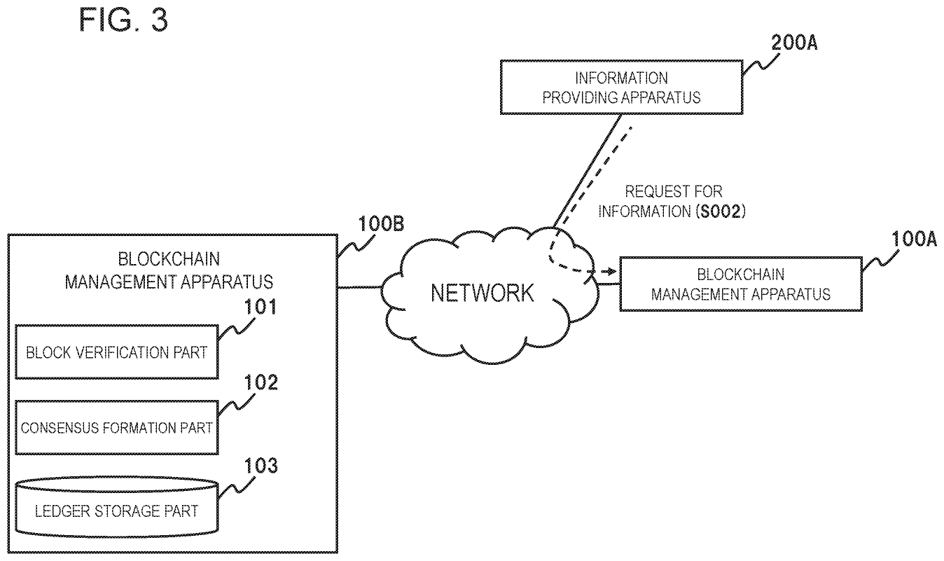

The information providing apparatus 200A that receives the information request provides information required for creation of a block to the blockchain management apparatus 100A, as shown in FIG. 3 (step S002).

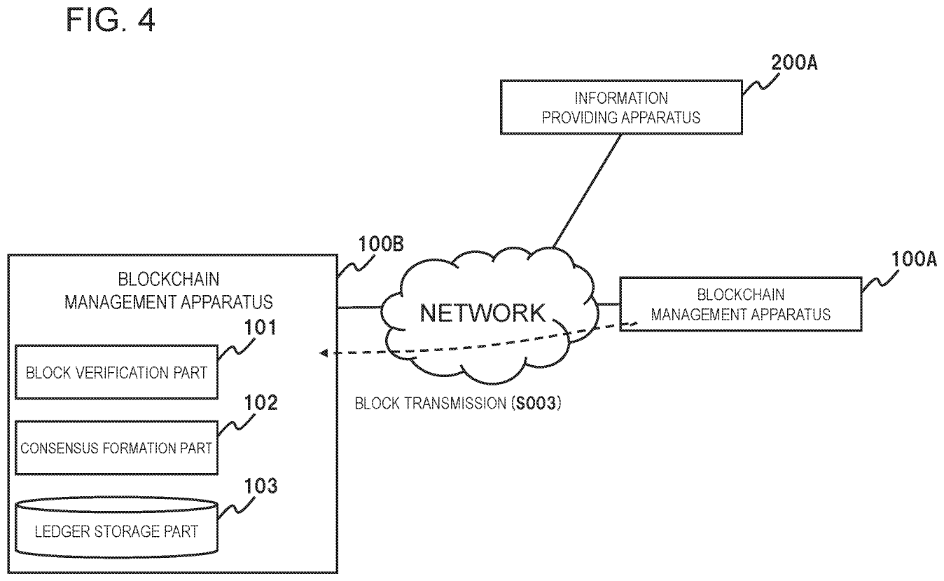

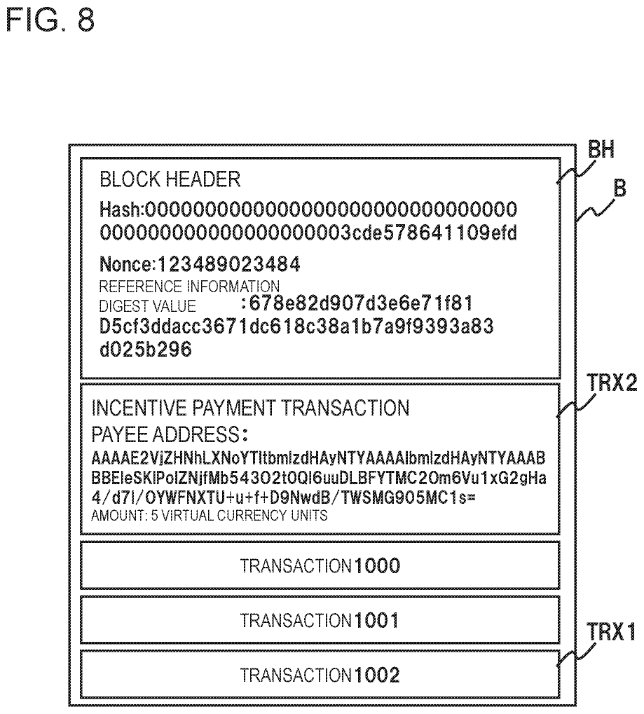

The blockchain management apparatus 100A uses partial information of a ledger it itself holds and information provided by the information providing apparatus 200A as necessary, to calculate for example a hash value, a Nonce or the like for the block. The blockchain management apparatus 100A generates a block to which a reference information digest value and a second transaction whereby consideration for providing the ledger information is paid to the payment address, are added to this information. Here it is possible to use a digest value (hash) generated from ledger information generated by a prescribed rule and payment address, as the reference information digest value (refer to reference information value of FIG. 8). In addition the blockchain management apparatus 100A, as shown in FIG. 4, transmits the generated block to another blockchain management apparatus (in FIG. 4, blockchain management apparatus 100B).

The second blockchain management apparatus 100B (corresponding to the abovementioned second blockchain management apparatus) performs verification processing to confirm whether at least an appropriate reference information digest value and an appropriate second transaction are included in the received block.

The consensus formation part 102, in a case of success in the block verification, forms a consensus with another blockchain management apparatus, and the block for which consensus has been formed is added to a ledger stored in the ledger storage part 103.

According to the abovementioned configuration, the block that includes the second transaction is recorded in the ledger. As a result, an installer or administrator of the information providing apparatus 200A can receive consideration for information provision by the information providing apparatus 200A, according to the second transaction. Therefore, it is possible to give an incentive for holding ledger data to the installer or administrator of the information providing apparatus 200A. Meanwhile, the installer or administrator of the blockchain management apparatus can integrate management resources, for improved mining capability of the blockchain management apparatus. In this way, a node whose mining capability is not high but has surplus storage, or conversely a node whose mining capability is high but does not have surplus storage, or a node in between these can cooperate to obtain consideration for block generation.

### First Exemplary Embodiment

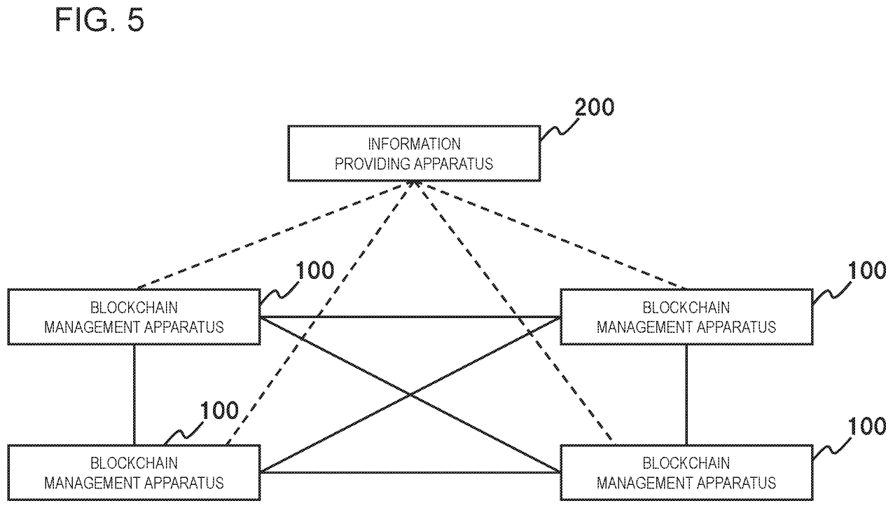

Next, a detailed description is given concerning a first example embodiment of the present invention, making reference to the drawings. FIG. 5 is a diagram showing a configuration of the first example embodiment of the present invention. FIG. 5 shows a configuration in which 1 information providing apparatus 200 and 4 blockchain management apparatuses (blockchain management nodes) 100 are connected to each other. These blockchain management apparatuses 100 verify transactions received from a transaction publisher. The blockchain management apparatuses 100 use information provided by the information providing apparatus 200 to integrate transactions that have passed verification and create a block. A blockchain management apparatus 100 that has created the block distributes the created block to other blockchain management apparatuses 100. On verifying the correctness thereof, the respective blockchain management apparatuses 100 add block content to a ledger. It is to be noted that in the abovementioned process, since the blockchain management apparatuses 100 may be a block creation agent, blocks with different content may be created. In a case where a malicious blockchain management apparatus 100 exists, there is a possibility of a fraudulent block being created and distributed. In this case, a procedure known as consensus formation is performed, and contents of blocks stored among the blockchain management apparatuses 100 are made identical. Thus, ledger consistency is preserved. It is to be noted that in the example of FIG. 5, 4 blockchain management apparatuses are shown, but it is sufficient if there are plural blockchain management apparatuses, and there is no limitation to the configuration of FIG. 5. The information providing apparatus 200 may function as a blockchain management apparatus.

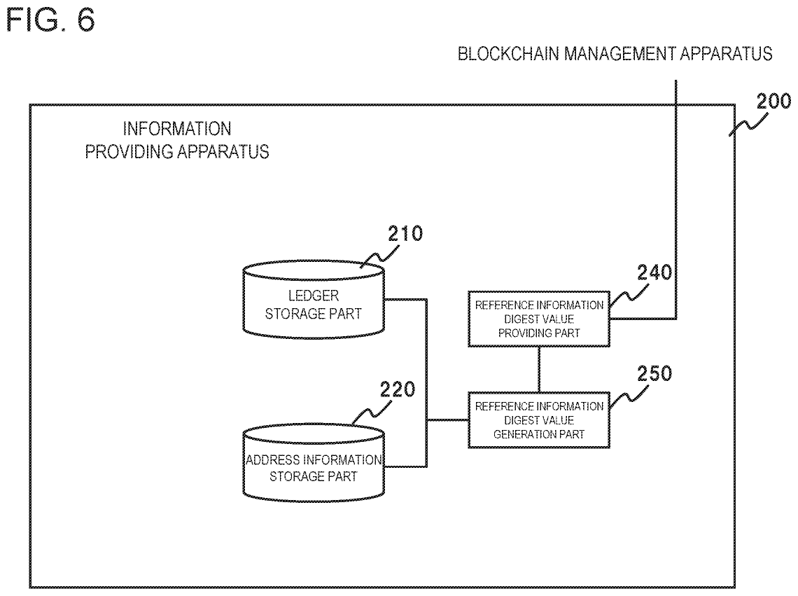

Continuing, a detailed description is given concerning a configuration of the information providing apparatus 200, making reference to the drawings. FIG. 6 is a functional block diagram showing a configuration of the information providing apparatus in the first example embodiment of the invention. FIG. 6 shows the information providing apparatus 200 including a ledger storage part 210, an address information storage part 220, a reference information digest value providing part 240, and a reference information digest value generation part 250.

The ledger storage part 210 stores a ledger which is a set of blocks for which consensus has been formed among blockchain management apparatuses. It is to be noted that the information providing apparatus 200 itself may perform ledger updating, or another blockchain management apparatus may perform the ledger updating. It is to be noted that the ledger storage part 210 need not hold all ledger data. For example, the information providing apparatus 200 may have a configuration to obtain ledger data from another apparatus (including a case where the apparatus is the same as the information providing apparatus 200).

The address information storage part 220 stores a payment address for consideration with respect to provision of information stored in the ledger storage part 210, to the blockchain management apparatus by the information providing apparatus. As an example of this payment address, in Bitcoin (registered trademark) a Bitcoin address may be cited. Clearly, if there is a suitable payment address of a transaction that can be recorded in a block, a payment address of another virtual currency or bank account information is also possible.

The reference information digest value providing part 240 provides a digest value (referred to below as “reference information digest value”) of information (referred to below as “reference information”) selected by a prescribed rule from a ledger stored in the ledger storage part 210 and a payment address, in response to a request from the blockchain management apparatus 100. More specifically, the reference information digest value providing part 240 makes a request for generation of the reference information digest value to the reference information digest value generation part 250. On receiving the reference information digest value from the reference information digest value generation part 250, the reference information digest value providing part 240 transmits the reference information digest value to the blockchain management apparatus 100 that is the source of the request.

The reference information digest value generation part 250 retrieves the payment address and reference information specified by the reference information digest value providing part 240, from the ledger storage part 210 and the address information storage part 220 respectively, and generates the reference information digest value. The reference information digest value is calculated by a prescribed calculation method. For example, the reference information and the payment address may be linked and a hash value thereof may be taken as a reference information digest value.

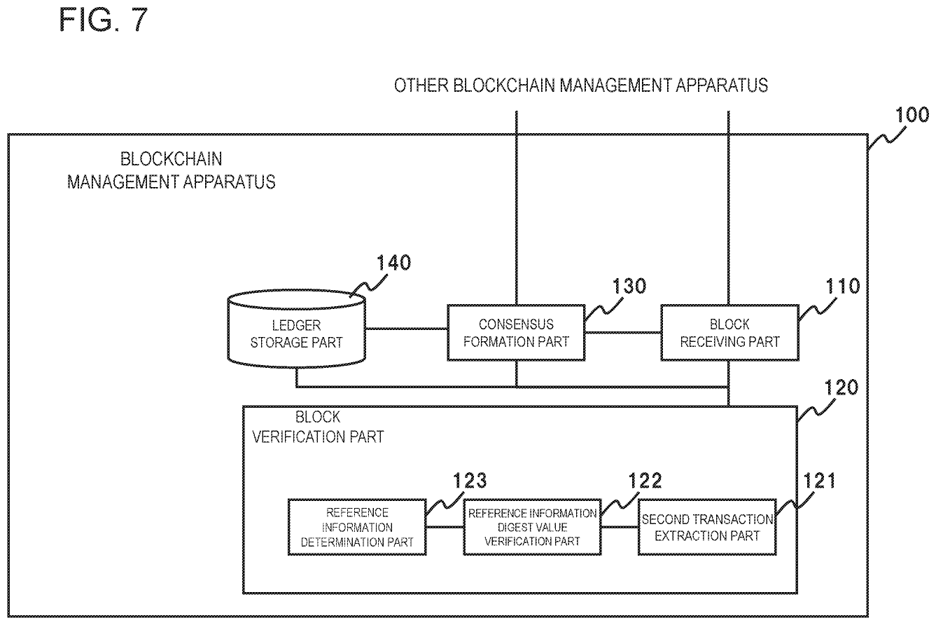

Continuing, a detailed description is given concerning a configuration of a blockchain management apparatus 100, making reference to the drawings. FIG. 7 is a functional block diagram showing a configuration of the blockchain management apparatus in the first example embodiment of the invention. FIG. 7 shows the blockchain management apparatus 100 including a block receiving part 110, a block verification part 120, a consensus formation part 130, and a ledger storage part 140.

The block receiving part 110 receives a block transmitted to a blockchain network. The block B, as shown in FIG. 8, is configured by adding a block header BH to 1 or a plurality of transactions. Furthermore, the block header BH includes a block header digest value (Hash in FIG. 8) that summarizes a block header included in the immediately preceding block, and the reference information digest value. In addition, block B which is determined to be valid in the present example embodiment stores a transaction TRX2 different from a normal transaction TRX1, called an incentive payment transaction. The incentive payment transaction TRX2 corresponds to the abovementioned second transaction, and includes payment amount and payment address provided along with the reference information digest value from the information providing apparatus 200. It is to be noted that the reference information may be determined by a prescribed rule shared with the blockchain management apparatus 100, and may be in a plurality of ledger parts. In this case, there are plural reference information items, and 1 or a plurality of reference information digest values are generated from these plural reference information items.

The block verification part 120 includes a second transaction extraction part 121, a reference information digest value verification part 122, and a reference information determination part 123, and verifies that a received block is correctly generated. Specifically, the second transaction extraction part 121 extracts the abovementioned incentive payment transaction (second transaction) from the received block.

The reference information determination part 123 determines reference information which is partial information of a ledger based on some or all information of the ledger, based on the prescribed rule. It is to be noted that the prescribed rule may be a rule whereby all blockchain management apparatuses 100 can identify reference information that is the same partial information, from ledger information. A case of using a type of rule whereby a ledger is selected that is not present in (is discarded from) the ledger storage part 140 of the blockchain management apparatus as reference information, is described in the third example embodiment.

The reference information digest value verification part 122 performs confirmation as to whether or not a block is generated in accordance with a blockchain stipulated rule, and in addition performs verification of the block from the following viewpoints. First the reference information digest value verification part 122 uses payment address information included in the incentive payment transaction (second transaction) and reference information determined by the reference information determination part 123 to calculate a reference information digest value. In a case where the reference information digest value matches a reference information digest value included in the block, the reference information digest value verification part 122 determines that the block has been correctly generated.

The consensus formation part 130, in a case of determining that the received block has been correctly generated by the block verification part 102, implements a consensus formation procedure concerning whether the block in question is stored in the ledger storage part 140, with other blockchain management apparatuses.

The ledger storage part 140 stores at least some of a ledger that is an aggregation of blocks for which a consensus has been formed by the consensus formation part 130.

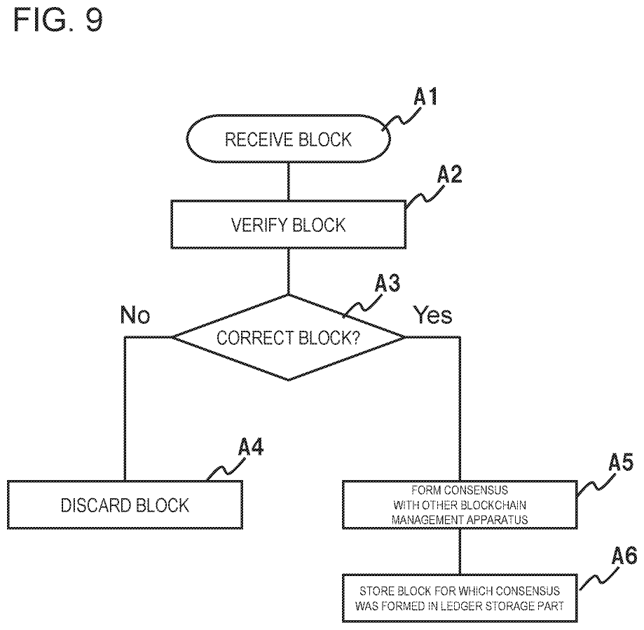

Next, a detailed description is given concerning operations of a blockchain management apparatus 100, making reference to the drawings. First, referring to FIG. 9 a description is given of a series of operations in which the blockchain management apparatus 100 verifies a received block, up to storing in the ledger storage part 140.

The block receiving part 110 receives a block from another blockchain management apparatus 100 or the like (step A1). Here, the block B shown in FIG. 8 is received. As shown in FIG. 8, the block B has a configuration in which a block header including a block header digest value (Hash) that summarizes a block header of the immediately preceding block, a value known as a Nonce used by the consensus formation part 130, and a reference information digest value, are added to a body that is an aggregation of transactions. An incentive payment transaction (second transaction) is included in the body of the block B.

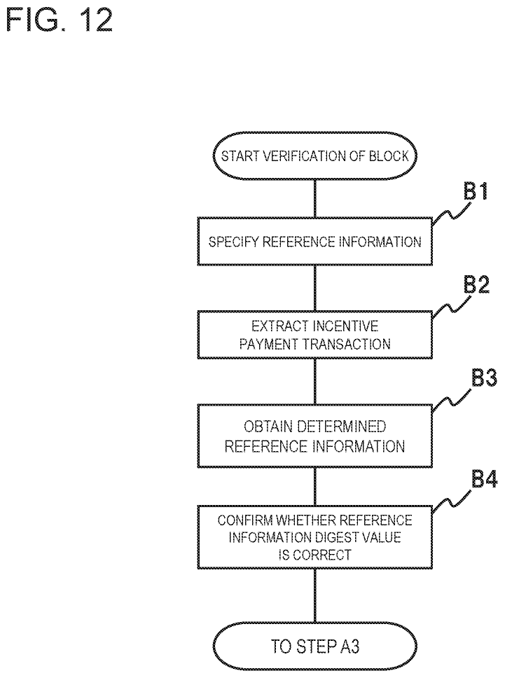

Next, the block verification part 120 performs verification on the received block B (step A2). A description is given later concerning content of this verification, using the flowchart of FIG. 12.

As a result of the verification, in a case where it is determined that the block has not been correctly generated (No in step A3), the blockchain management apparatus 100 discards the block (step A4).

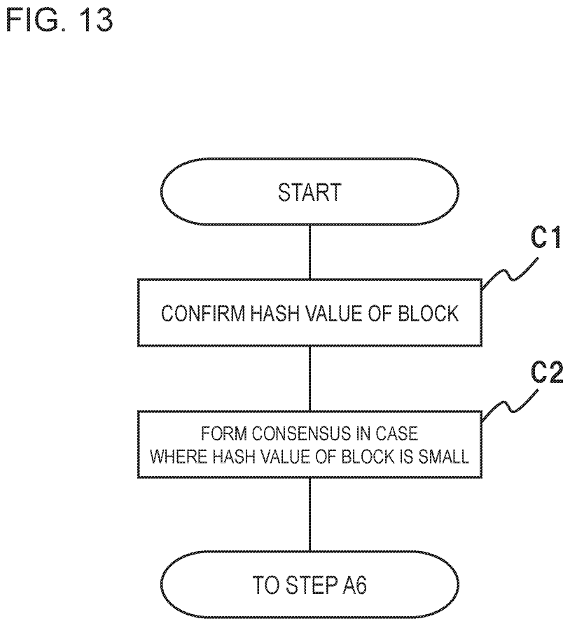

Meanwhile, in a case of a determination being made that a block has been generated correctly (Yes in step A3), the consensus formation part 130 performs consensus formation with another blockchain management apparatus(es) 100 (step A5). A description is given later concerning a method for the consensus formation using the flowchart of FIG. 13.

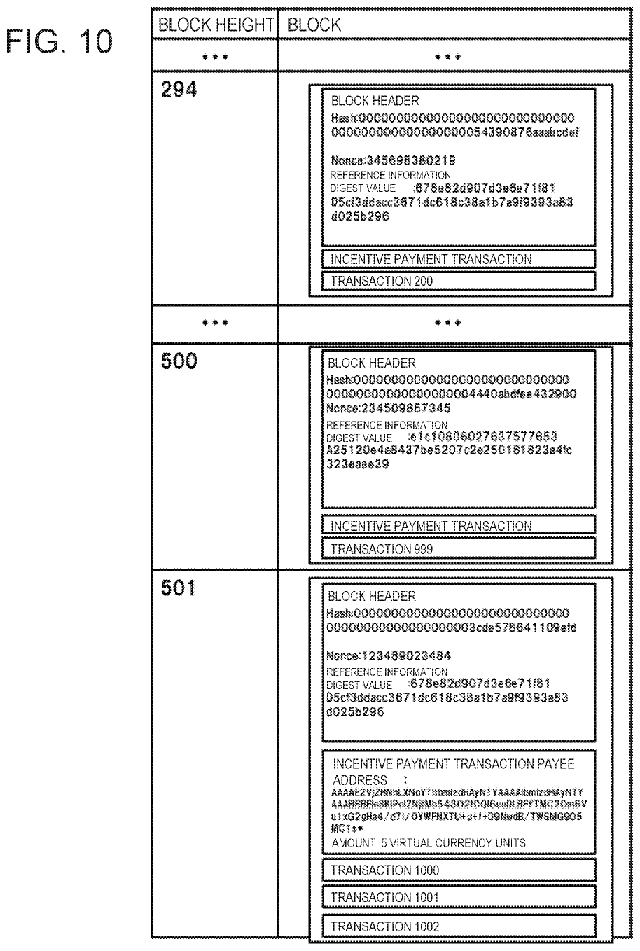

Finally, the blockchain management apparatus 100 stores the block for which consensus has been formed with another blockchain management apparatus(es) 100, in the ledger storage part 140 (step A6). FIG. 10 is a diagram showing an example of ledger data held in the ledger storage part 140. In the example of FIG. 10 the result of the consensus formation shows a state in which a block with block height 501 is added. It is to be noted that the storage state of the ledger in the ledger storage part 140 is not limited to the example shown in FIG. 10, and various modifications may be added. For example, the example of FIG. 10 has a configuration associating the height of the block and the main unit of the block, but the configuration is not limited to this form.

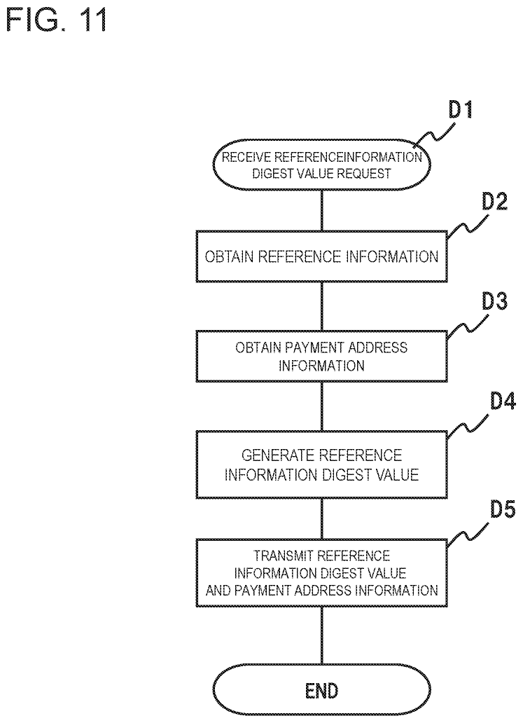

Continuing, a description is given of operations of the information providing apparatus 200 that provides information required for creating a block, to the blockchain management apparatus 100 that generates the block shown in FIG. 8 described above, using the flowchart of FIG. 11.

Referring to FIG. 11, first the information providing apparatus 200 receives a transmission request for a reference information digest value, from the blockchain management apparatus 100 that generates the block (step D1).

Next, the information providing apparatus 200 retrieves reference information which is partial information of a ledger based on some or all information of the ledger, based on the prescribed rule, from the ledger storage part 210 (step D2).

Next, the information providing apparatus 200 retrieves payment address information from the address information storage part 220 (step D3).

Next, the information providing apparatus 200 generates a reference information digest value using the reference information and payment address information (step D4).

Next, the information providing apparatus 200 transmits the generated reference information digest value and the payment address information to the blockchain management apparatus 100 that is the transmission source of a transmission request for the reference information digest value (step D5).

From the above, the blockchain management apparatus 100 creates the block shown in FIG. 8 using the reference information digest value and payment address information received from the information providing apparatus 200.

Continuing, a detailed description is given concerning verification processing of a block by the block verification part 120 in step A2 of the abovementioned FIG. 9, using the flowchart of FIG. 12. Below, a description is given in which the blockchain management apparatus 100 receives the block shown in FIG. 8.

When the block that is a target for verification is inputted, first the reference information determination part 123 of the block verification part 120 generates at least 1 identifier that can discern (identify) partial information in the ledger, in accordance with the prescribed rule, and specifies the reference information (step B1).

The height of the block, for example, may be used for the identifier of the reference information (refer to FIG. 8). The following may be used, for example, for the prescribed rule that specifies the reference information.
A hexadecimal numerical value is created using a hash function such as SHA-256 for a part of the immediately preceding block (Nonce value, or hash value of the immediately preceding block, or the like).
1 is added to a value obtained by performing a remainder operation with the height of the latest block with respect to a portion (lower digits) of the numerical value.

By using the abovementioned rule, it is possible to determine what height block to specify as reference information among block height 1 to the current block height.

For example, a hash value is taken with a SHA-256 hash function for a hash value (that is, a hash value of a block header of height 499) of the immediately preceding block included in a block of height 500 that is the immediately preceding block in the ledger shown in FIG. 10. Here, a value of ‘9a796cbfa5cc884d7f3e7ddf6c743dfeb9a78e876766d3243e893e4ded4e6 38d’ is obtained as the hash value. A block referenced by obtaining the remainder with the current block height of 500 for the least significant 16 digits of the hexadecimal number: ‘3e893e4ded4e638d’, and adding 1, is “294”.

It is to be noted that there is no limitation to the identifier of the reference information or the determination method thereof. For example, the identifier of the reference information may be configured from plural information items such as block height and a number to identify a transaction in the block. Identifiers configured by these plural information items may be obtained from plural partial information items of the immediately preceding block, or may be respectively generated from a plurality of immediately preceding blocks. There may be a plurality of identifiers of the reference information, and plural reference information items may be specified.

For an identifier for selecting the abovementioned reference information, information by which reference information can be identified from within the ledger is sufficient and there is no limitation with regard to form thereof. The identifier of the reference information may be an identifier whereby partial information of the ledger is selected uniformly to some extent.

Next, the second transaction extraction part 121 of the block verification part 120 extracts an incentive payment transaction TRX2 from the received block (step B2).

Next, the reference information digest value verification part 122 obtains reference information determined by the reference information determination part 123 from the ledger storage part 140 (step B3).

Next, the reference information digest value verification part 122 uses payment address information included in the incentive payment transaction TRX2 and the reference information to calculate a reference information digest value. In a case where the reference information digest value matches a reference information digest value included in the block, a determination is made that the block has been correctly generated (step B4).

It is to be noted that in a case where there are plural reference information items, one reference information digest value may be verified according to a linkage of these and payment address information, or verification may be performed with reference information corresponding to each of the plural reference information digest values and payment address information. The verification method is not limited to the abovementioned method, and it is sufficient if it can be verified that the reference information digest value is generated from the reference information and the payment address information.

Continuing, a detailed description is given concerning consensus formation processing by the consensus formation part 130 in step A5 of the abovementioned FIG. 9. It is to be noted that the following is a description of consensus formation by a mechanism called Proof of Work which is used in Bitcoin for example, but other consensus methods are also possible and there is no limitation with regard to method of consensus formation.

Referring to FIG. 13, first the consensus formation part 130 confirms a hash value of a block (step C1). The hash value may be obtained for an entire block, or may be obtained for a value that summarizes a feature of the block. Here a description is given in which an obtained value is: “0000000000000000000000000000000000000000000000002bcad85e7b4 0d3a4” in hexadecimal, as the hash value of the block shown in FIG. 8.

Finally, the consensus formation part 130 determines whether or not the hash value of the block is smaller than a target value, and in a case where the hash value of the block is small, determines that a consensus has been formed (step C2). Here for a target value (Difficulty) a unique value may be determined in advance in a system, or may be generated by calculation referring to a former block. Here in a case where a target value for the block shown in FIG. 8 is “00000000000000000000000000000000000000000000000100000000000 00000”, since the hash value of the block of FIG. 8 described above is less than the target value in question, a consensus formation is determined to have been made.

This type of consensus formation method is known as Proof of Work; when a block is generated, a value known as a Nonce as shown in the block of FIG. 8 is changed, and a block is generated such that a hash value of the block is smaller than the target value. Since it is not possible to reverse calculate a Nonce from the hash value, the blockchain management apparatus 100 must test the Nonce by brute force. Therefore, a certain calculation cost and time are required in generating a block. The time required for block generation can be controlled according to target value; for example, in Bitcoin, from generation interval for the most recent few blocks, adjustment is performed such that henceforth the time required in generating a block is of the order of 10 minutes. The consensus formation part 130 that uses Proof of Work can verify whether or not a block is one generated having a calculation cost by the hash value of the block. The majority of blockchain management apparatuses 100 participating in a blockchain network verify a hash value of a block in accordance with the same rule, and by having only blocks that pass verification as blocks stored in the ledger storage part 140, it is possible to form consensus in the entire network.

As described above, according to the blockchain management apparatus 100 and the information providing apparatus 200 of the present example embodiment, it is possible to form consensus at a block including an incentive payment transaction TRX2 that forms consideration for information provision to the information providing apparatus 200, and to make a record in the ledger. In other words, according to the present example embodiment, it is possible to separate an incentive with respect to holding a transaction and an incentive with respect to block generation (mining).

This means that all the blockchain management apparatuses 100 need not hold all transactions, and that a specific blockchain management apparatus 100 can be dedicated to block generation (mining). That is, among nodes participating in the blockchain, an entity to which mining remuneration is appealing can reduce storage costs, can concentrate limited computational resources in block generation (mining) and can obtain mining remuneration more efficiently.

On the other hand, according to the present example embodiment, it is possible to give remuneration also to the information providing apparatus 200 side that holds the transaction. In this way, it is possible to curb the possibility of ledger data loss in a blockchain.

### Second Exemplary Embodiment

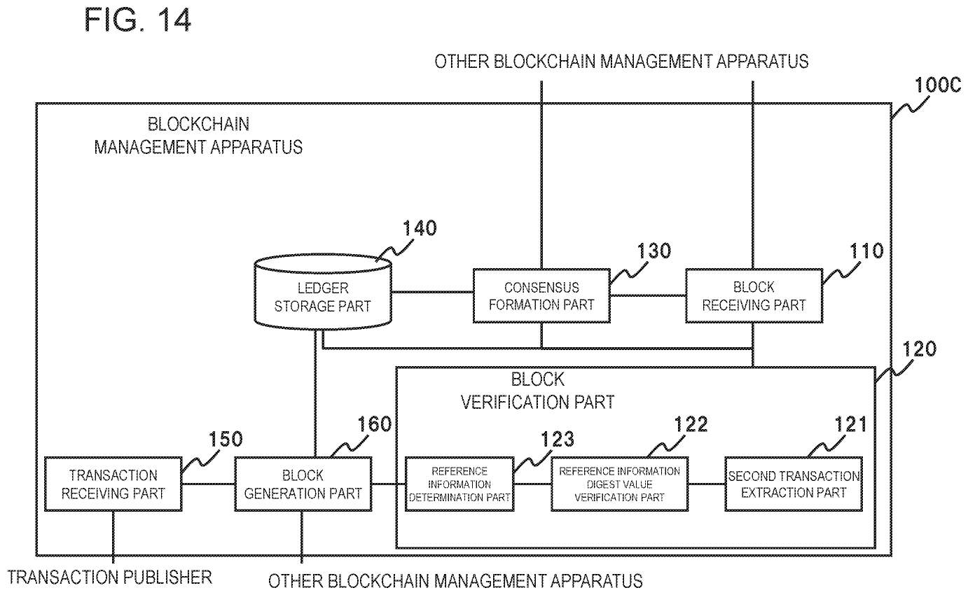

In the abovementioned example embodiment a mechanism in which a blockchain management apparatus 100 receives a transaction from a transaction publisher to generate a block was omitted, but the blockchain management apparatus 100 may also be provided with such functions. As in FIG. 14 for example, the blockchain management apparatus 100C may be provided with a transaction receiving part 150 and a block generation part 160 (second example embodiment).

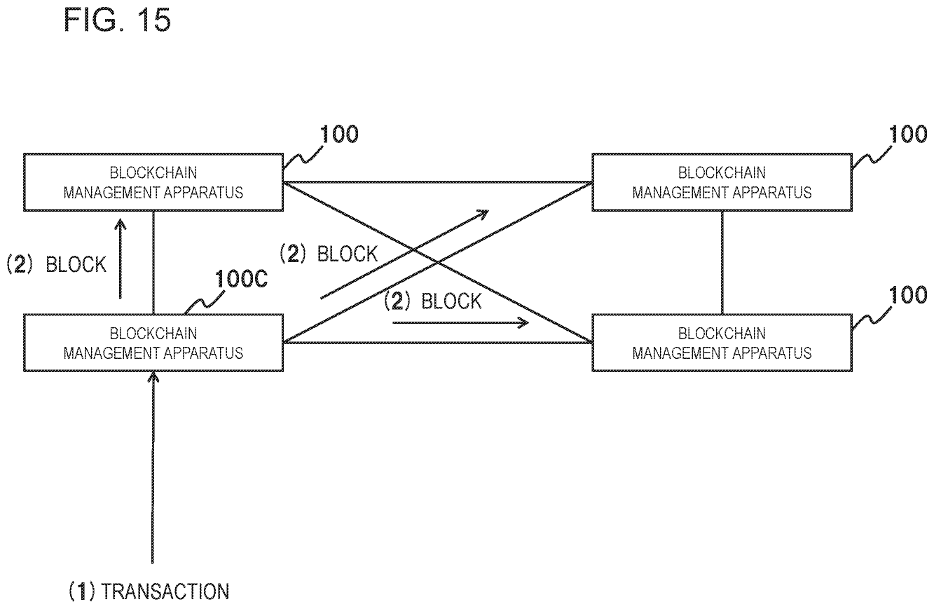

The transaction receiving part 150 receives a transaction from a transaction publisher or another blockchain management apparatus 100 (refer to (1) in FIG. 15). A block generation part 160 collects a hash value of the immediately preceding block stored in a ledger storage part 140, a reference information digest value, and a transaction including an incentive payment transaction, to generate a block and distribute to another blockchain management apparatus(es) 100 ((2) in FIG. 15). Since subsequent operations are similar to the first example embodiment, a description is omitted.

As described above, a verification function of the block may also be provided in the blockchain management apparatus 100 that is provided with a function to generate a block on receiving a transaction.

### Third Exemplary Embodiment

In the abovementioned example embodiment a description was given where a blockchain management apparatus 100 obtained reference information from its own ledger storage part 140 when verifying a block, but reference information may also be obtained from an information providing apparatus.

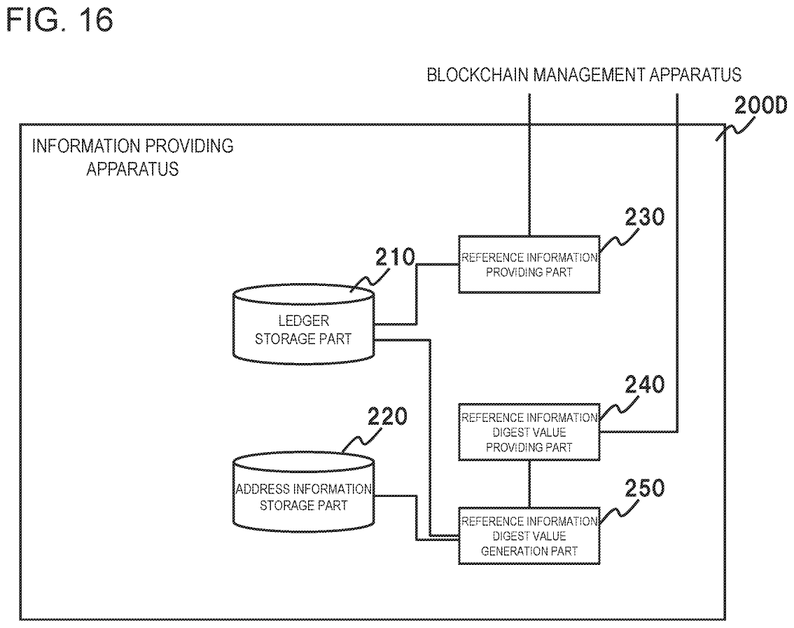

FIG. 16 is a functional block diagram showing a configuration of the information providing apparatus in a third example embodiment of the invention. A point of difference from the first information providing apparatus 200 shown in FIG. 6 is that a reference information providing part 230 is added to the information providing apparatus 200A.

The reference information providing part 230 retrieves reference information from a ledger storage part 210 based on a transmission request for reference information from the blockchain management apparatus 100D and transmits it to the blockchain management apparatus 100D. It is to be noted that a malicious blockchain management apparatus can, by receiving reference information, create a reference information digest value. Therefore, the reference information providing part 230 preferably provides a condition for the blockchain management apparatus 100, such as, as timing of transmitting the reference information, the elapse of sufficient time after the block arrival, or the arrival of the next block. This reference information providing part 230 corresponds to a second information providing part.

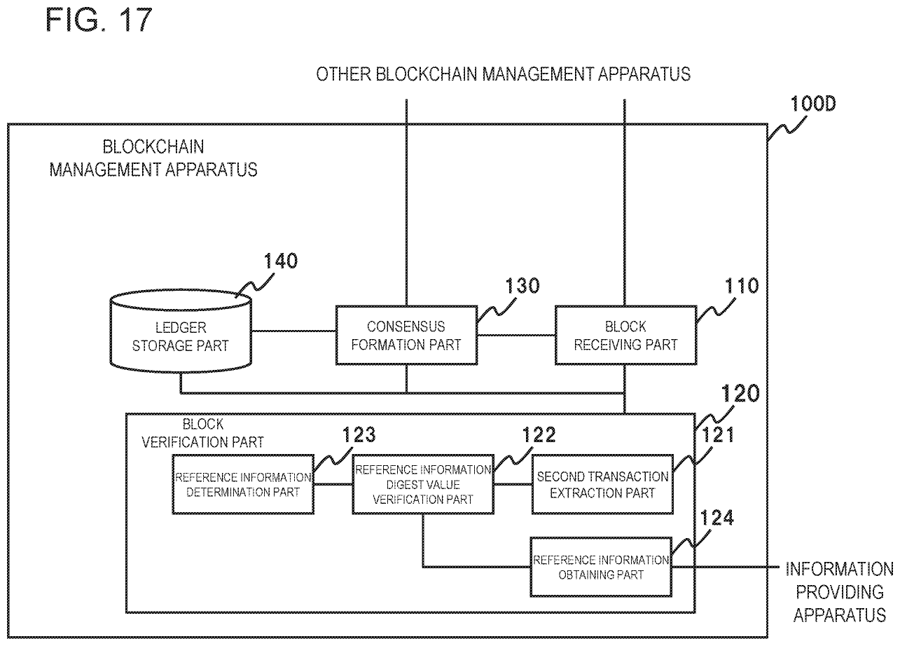

FIG. 17 is a diagram showing a configuration of a blockchain management apparatus 100D provided with a function for obtaining reference information. A point of difference from the blockchain management apparatus 100 shown in FIG. 7 is the point that a reference information obtaining part 124 is added inside the block verification part 120.

The reference information obtaining part 124 requests transmission of reference information determined by a reference information determination part 123, and receives reference information from the information providing apparatus 200. The reference information obtaining part 124 sends the received reference information to the reference information digest value verification part 122. It is to be noted that information (an identifier) to identify block height and reference information is included in the request for reference information transmitted to the information providing apparatus 200A by the reference information obtaining part 124.

The reference information digest value verification part 122 uses payment address information included in the incentive payment transaction (second transaction) and reference information obtained at the reference information obtaining part 124, to calculate a reference information digest value. In a case where the reference information digest value matches a reference information digest value included in the block, a determination is then made that the block has been correctly generated.

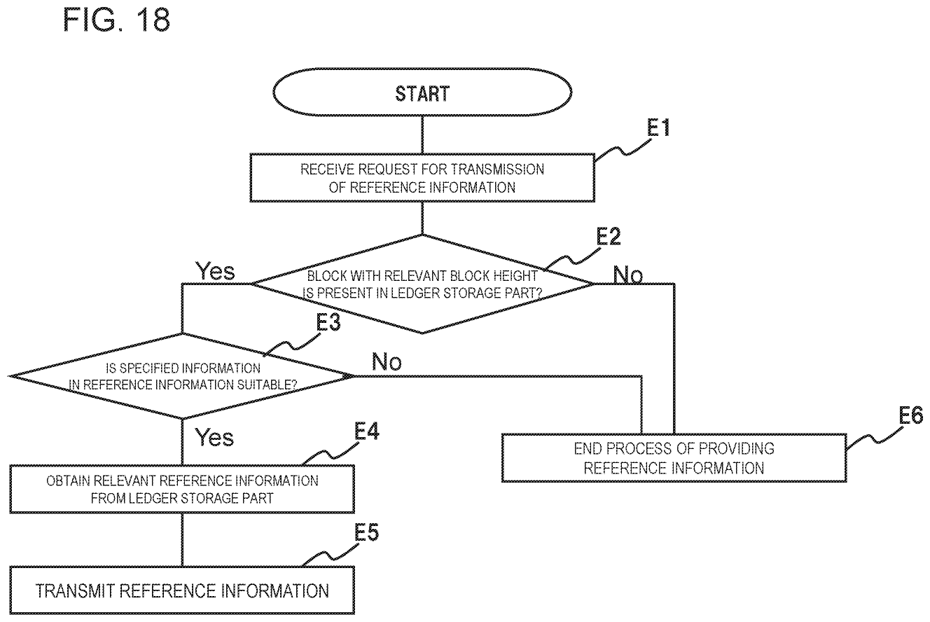

FIG. 18 is a flowchart representing operations of the information providing apparatus 200A in the third example embodiment of the invention. Referring to FIG. 18, on receiving a transmission request for reference information from the blockchain management apparatus 100D (step E1), the information providing apparatus 200A confirms whether or not a block with the relevant block height is present in the ledger storage part 210 (step E2). Here, in a case where there is no block of the relevant block height, the information providing apparatus 200A ends processing (step E6).

On the other hand, in a case where a block of the relevant block height is present in the ledger storage part 210, the information providing apparatus 200A confirms whether or not information (an identifier) to identify reference information is suitable (step E3). Here, in a case where the information (an identifier) to identify the reference information is not suitable, the information providing apparatus 200A ends processing (step E6).

On the other hand in a case where the information (an identifier) to identify the reference information is suitable, the reference information providing part 230 of the information providing apparatus 200A retrieves relevant reference information from the ledger storage part 210 and transmits it to the blockchain management apparatus 100. Since subsequent operations are similar to the first example embodiment, a description thereof is omitted.

As described above, according to the present example embodiment it is possible to perform block verification even in a case where reference information is removed from the ledger storage part 140 of the blockchain management apparatus 100. That is, as a rule (prescribed rule) for determining reference information, it is possible to use a rule assuming receiving reference information from the information providing apparatus 200, and it is possible to reduce storage costs.

A description has been given above of respective example embodiments of the present invention, but the present invention is not limited to the abovementioned example embodiments, and further modifications, substitutions and adjustments may be added within a scope that does not depart from fundamental technical concepts of the invention. Network configurations, respective element configurations and message expression forms shown in the respective drawings are examples for the purpose of aiding understanding of the invention, and are not intended to limit the invention to configurations illustrated in the drawings.

For example, the respective parts (processing means) of the blockchain management apparatuses and information providing apparatuses shown in FIGS. 1, 6, 7, 14, 16 and 17 may be implemented by a computer program that executes the abovementioned respective processing in a processor installed in these apparatuses, using hardware thereof.

Finally, preferred modes of the present invention are summarized.

### <First Mode>

(Refer to the blockchain management system according to the first aspect described above.)

### <Second Mode>

(Refer to the first blockchain management apparatus according to the second aspect described above.)

### <Third Mode>

(Refer to the second blockchain management apparatus according to the third aspect described above.)

### <Fourth Mode>

(Refer to the information providing apparatus according to the fourth aspect described above.)

### <Fifth Mode>

The second blockchain management apparatus is preferably provided with an information obtaining part that obtains information required for block verification, from the information providing apparatus.

### <Sixth Mode>

The second information providing part of the abovementioned information providing apparatus is preferably provided with a second information providing part (reference information providing part) that extracts and provides information required for verifying the block from the ledger storage part, in response to a request from a prescribed blockchain management apparatus.

### <Seventh Mode>

The abovementioned second information providing part further preferably provides, after a prescribed time has elapsed from arrival of a block, information required for the verifying the block, in response to a request from the prescribed blockchain management apparatus.

### <Eighth Mode>

The second information providing part of the abovementioned information providing apparatus preferably provides, in a case of determining to be correct a combination of the height of a block included in a request from the prescribed blockchain management apparatus and information for identifying information required for verifying the block, information required for verifying the block.

### <Ninth Mode>

(Refer to the blockchain management method according to the fifth aspect described above.)

### <Tenth Mode>

(Refer to the computer program according to the sixth aspect described above.)

It is to be noted that the various disclosures of the abovementioned Patent Literature and Non-Patent Literature are incorporated herein by reference thereto. Modifications and adjustments of example embodiments and examples may be made within the bounds of the entire disclosure (including the scope of the claims) of the present invention, and also based on fundamental technological concepts thereof. Various combinations and selections of various disclosed elements (including respective elements of the respective claims, respective elements of the respective example embodiments and examples, respective elements of the respective drawings and the like) are possible within the scope of the disclosure of the present invention. That is, the present invention clearly includes every type of transformation and modification that a person skilled in the art can realize according to the entire disclosure including the scope of the claims and to technological concepts thereof. In particular, with regard to numerical ranges described in the present specification, arbitrary numerical values and small ranges included in the relevant ranges should be interpreted to be specifically described even where there is no particular description thereof.

### REFERENCE SIGNS LIST

100, 100A-100D blockchain management apparatus
101, 120 block verification part
102, 130 consensus formation part
103, 140, 210 ledger storage part
110 block receiving part
102, 120 block verification part
121 second transaction extraction part
122 reference information digest value verification part
123 reference information determination part
124 reference information obtaining part
150 transaction receiving part
160 block generation part
200, 200A information providing apparatus
220 address information storage part
230 reference information providing part
240 reference information digest value providing part
250 reference information digest value generation part
B block
BH block header
TRX1 transaction
TRX2 incentive payment transaction (second transaction)

1. A blockchain management system comprising:
an information providing apparatus that provides a prescribed payment address and a digest value generated from ledger information and the payment address, to the blockchain management apparatus;
a first blockchain management apparatus that uses information provided by the information providing apparatus to generate a block including a first transaction; and
a second blockchain management apparatus that comprises
a block verification part that verifies a block on a condition that the block received from the first blockchain management apparatus includes at least the digest value generated from the ledger information and payment address, and a second transaction whereby consideration for providing the ledger information is paid to the prescribed payment address, and
a consensus formation part that, in a case where verification of the block is successful, forms a consensus with another blockchain management apparatus and adds the block for which consensus was formed to the ledger.

2. The blockchain management system according to claim 1, wherein the second blockchain management apparatus comprises an information obtaining part that obtains information required for block verification, from the information providing apparatus.

3.-5. (canceled)

6. An information providing apparatus comprising:
a ledger storage part that manages a ledger configuring a blockchain;
an address information storage part that holds a payment address that is for paying a consideration for providing data held in the ledger storage part; and
an information providing part that provides a prescribed payment address and a digest value generated from the ledger information and the payment address, to a blockchain management apparatus.

7. The information providing apparatus according to claim 6, further comprising a second information providing part that extracts information required for verifying a block from the ledger storage part and provides the information in response to a request from a prescribed blockchain management apparatus.

8. The information providing apparatus according to claim 7, wherein the second information providing part, after a prescribed time has elapsed from arrival of a block, provides information required for verifying the block, in response to a request from the prescribed blockchain management apparatus.

9. The information providing apparatus according to claim 7, wherein the second information providing part, in a case of judging to be correct a combination of block height included in a request from the prescribed blockchain management apparatus, and information for identifying information required for verifying the block, provides information required for verifying the block.

10. A blockchain management method comprising:
verifying a block on a condition that a block includes at least a digest value generated from ledger information and a prescribed payment address, and a second transaction whereby consideration for providing the ledger information is paid to the prescribed payment address;
forming consensus with another blockchain management apparatus, in a case of success in verification of the block; and
adding the block for which the consensus formation has been done to the ledger.

11. The blockchain management method according to claim 10, comprising:
providing a prescribed payment address and a digest value generated from ledger information and the payment address; and
generating the block by using the prescribed payment address and the digest value.

12. The blockchain management method according to claim 11, comprising:
providing information required for verifying the block, in response to a request after a prescribed time has elapsed from arrival of the block.

13. The blockchain management method according to claim 11, comprising:
providing information required for verifying the block in a case of judging to be correct a combination of block height included in a request and information for identifying information required for verifying the block.

14. The blockchain management method according to claim 11, wherein the prescribed payment address and the digest value are provided by an information providing apparatus, the block is generated by a first blockchain management apparatus, and the block is verified by a second blockchain management apparatus.

15. The blockchain management method according to claim 12, wherein the information providing apparatus comprising:
a ledger storage part that manages the ledger configuring a blockchain;
an address information storage part that holds the payment address that is for paying a consideration for providing data held in the ledger storage part; and
an information providing part that provides the prescribed payment address and the digest value to the first blockchain management apparatus.

16. The blockchain management method according to claim 15, wherein the information providing apparatus comprising:
a second information providing part that extracts from the ledger storage part and provides information required for verifying the block in response to a request from the first blockchain management apparatus.

17. The blockchain management system according to claim 1, wherein the information providing apparatus comprising:
a ledger storage part that manages the ledger configuring a blockchain;
an address information storage part that holds a payment address that is for paying a consideration for providing data held in the ledger storage part; and
an information providing part that provides a prescribed payment address and a digest value generated from the ledger information and the payment address, to the first blockchain management apparatus.

18. The blockchain management system according to claim 17, wherein the information providing apparatus comprising:
a second information providing part that extracts information required for verifying a block from the ledger storage part and provides the information in response to a request from the first blockchain management apparatus.

19. The blockchain management system according to claim 18, wherein the second information providing part, after a prescribed time has elapsed from arrival of a block, provides information required for verifying the block, in response to a request from the first blockchain management apparatus.

20. The blockchain management system according to claim 18, wherein the second information providing part, in a case of judging to be correct a combination of block height included in a request from the prescribed blockchain management apparatus, and information for identifying information required for verifying the block, provides information required for verifying the block.
